(19) United States
(12) Patent Application Publication
(10) Pub. No.: US 2006/0251160 A1
(43) Pub. Date: Nov. 9, 2006

(54) FDR single ended line testing (SELT) system and method for DSL modems

(76) Inventors: Amir H. Fazlollahi, San Jose, CA (US); Xiangguo Tang, Union City, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/339,865

(22) Filed: Jan. 25, 2006

Related U.S. Application Data
(60) Provisional application No. 60/647,485, filed on Jan. 26, 2005.

(51) Int. Cl. H04B 1/38

(52) U.S. Cl. 375/222

(57) ABSTRACT

A single ended line testing (SELT) method using a Frequency-Domain Reflectometry (FDR) that uses one or more echo signals originated by transmitting a periodic multi-tone sign, e.g., a REVERB signal, reflected from the hybrid and analyzes it in frequency domain. The REVERB signal is part of the ADSL modem training signal. Therefore the invention can be simply implemented as part of the DMT-based DSL modem because transmitting a multi-tone signal and capturing the frequency response of echo are readily available through the inverse fast Fourier transform/fast Fourier transform (IFFT/FFT) blocks that are used for modulation and demodulation.

### RELATED APPLICATION

This application claims priority from U.S. provisional application No. 60/647,485 filed on Jan. 26, 2005 which is incorporated by reference herein in its entirety.

### FIELD OF THE INVENTION

The invention relates generally to communications systems and more particularly to testing of a communication system having a transmission line that may or may not be terminated by load impedance.

### BACKGROUND OF THE INVENTION

In communication systems, single ended line testing (SELT) is used to test a loop configuration from one end of a communication line with no cooperative testing equipment connected at the other end. The loop configuration, such as loop length, gauge, presence and location of bridge-taps, etc. is an important piece of information for a broadband service provider in order to estimate the achievable data rate before signing up a customer. As a post-deployment troubleshooting tool, SELT can be used to recognize if a short circuit or open circuit has happened on the line in the case of a connection failure problem.

SELT may be implemented on a sophisticated piece of equipment or may be implemented in the broadband modem at the service provider side using, for example, an asymmetric digital subscriber line (ADSL). From the service provider perspective it is desirable to have a modem capable of implementing SELT where every modem port can be a SELT testing device if needed although this is not always the situation.

In the situation where there is no cooperative equipment at the receiving end of a communications line, SELT solely relies on analyzing the reflection of the signal transmitted from the transmitting side of the line. SELT may be categorized by two main techniques: Time-Domain Reflectometry (TDR), and Frequency-Domain Reflectometry (FDR). TDR is the more popular SELT technique that has been widely used, as described in, for example: Galli, S.; Waring, D. L.; “Loop makeup identification via single ended testing: beyond mere loop qualification”, Selected Areas in Communications, IEEE Journal on, Volume: 20, Issue: 5 , Jun. 2002, Pages: 923-935; U.S. Pat. No. 6,531,879; U.S. Pat. No. 6,538,451; and U.S. Pat. No. 5,128,619, which are all incorporated by reference herein in their entirety. In TDR a pulse (or pulses) is (are) transmitted into the line by the testing equipment that also monitors the reflected signal at the tip and ring to capture the sign and delay caused by receiver end impedance mismatch and bridge taps (BTs). The reflection information can be used to estimate loop length and BT locations. However, for an ADSL modem, the band-limiting transformer and analog filters introduce significant channel dispersion to the transmitted pulse and its reflections. It becomes more difficult to detect the sign and delay of the reflections in time domain.

The FDR methods usually require access to low-frequency band, e.g., as described in U.S. Pat. No. 6,668,041 and U.S. Pat. No. 5,864,602 which are incorporated by reference herein in their entirety, and/or require special hardware, e.g., as described in U.S. Pat. No. 6,434,221 and U.S. Pat. No. 6,487,276 which are incorporated by reference herein in their entirety, or use signaling that are not readily available in an ADSL modem, e.g., as described in U.S. Pat. No. 6,466,649 and U.S. Pat. No. 6,487,276 which are incorporated by reference herein in their entirety.

What is needed is a system and method for use in pre-deployment or post deployment of a DSL modem. In pre-deployment scenario, where there is no modem present at the other end of the line, what is needed is a system and method that can estimate loop length. In post-deployment scenario, what is needed is a troubleshooting system and method to recognize the state of the loop, i.e., whether the loop is open, short, or terminated and to estimate its length in case of service interruption.

### SUMMARY OF THE INVENTION

Embodiments of the present invention are single ended line testing (SELT) systems and methods using a Frequency-Domain Reflectometry (FDR) that use one or more echo signals originated by transmitting a periodic multi-tone signal, e.g., a REVERB signal, reflected from the hybrid and analyzed in the frequency domain. The REVERB signal is part of the ADSL modem training signal. Therefore the invention can be efficiently implemented as part of the DMT-based DSL modem because transmitting a multi-tone signal and capturing the frequency response of echo are readily available through the inverse fast Fourier transform/fast Fourier transform (IFFT/FFT) blocks that are used for modulation and demodulation.

The present invention is able to recognize, from one end of a twisted-pair DSL line, the state of the other end of the line, i.e., whether the other end is open, short, or terminated and can estimate the length of the open or short, point from the originating end of the line with reasonable accuracy. The originating end is a DSL modem that connects to the line using a four-to-two wire converter circuit called “hybrid”. This modem periodically transmits a wide-band multi-tone signal and measures its reflection, the echo signal, from the hybrid through its echo path at its receiver. By periodically transmitting this signal and averaging the captured echo signal over time the signal-to-noise ratio of the signal to be analyzed is improved. The echo path response of the hybrid is a function of the input impedance of the line Zᵢₙ. Zᵢₙ is the characteristic impedance of the line Z₀ as long as the other end is terminated by Z₀. Zᵢₙ deviates from Z₀ if the other end of the line is not terminated by Z₀. When the other end is short or open Zᵢₙ is significantly different from Z₀. For an open or short loop, the frequency response of Zᵢₙ will also vary based upon the length. This is due to the fact that an open or short loop, or any loop that is not terminated by Z₀, will create standing waves along the line if excited by a sinusoid. The amplitude function of the standing waves at each point along the line is the envelope of two added sinusoids with the same frequency but having different phases. This is a periodic function with period of λ/2 where λ=ν/f. “ν” is speed of electric wave in the transmission line and “f” is the frequency of the sinusoid. “ν” is in the range of speed of light. For a lossless line, the maximum and minimum of the standing waves will be constant along the line, however, for a loop with loss they will vary with loop length. At a given length “L” the amplitude of the standing wave will vary with “f”. Therefore, Zᵢₙ will have ripples in its amplitude frequency response for a loop that is not terminated by Z₀. The amplitude of these ripples A(f) and their period “T” are functions of the loop length “L”. By measuring A(f) and “T” we can recognize if the loop is open, short, or terminated by Z₀ and estimate the length “L”.

An advantage of one embodiment of the present invention is that it can be implemented on legacy platforms through a firmware upgrade as it does not require any special hardware, special switches, or any other change on the modem front-end circuitry communicating data through wired line. Another advantage is its simplicity as it uses wideband multi-tone signal for data collection that is used in regular modem training and is readily available.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a plot of the amplitude of the standing waves for resonant lossless line, with receiving end, open versus the distance from the receiving end in accordance with an embodiment of the present invention

FIG. 2 is a plot of the amplitude of the standing waves for resonant line with loss, with receiving end open, versus the distance from the receiving end in accordance with an embodiment of the present invention.

FIG. 3 is an amplitude frequency response of Zᵢₙ for a 2 Km open loop in accordance with an embodiment of the present invention.

FIG. 4 is an echo path amplitude frequency response of a typical hybrid circuit for a 1, 2, 3 Km open loop in accordance with an embodiment of the present invention.

FIG. 5 is an echo path response of a terminated 5 Km loop in accordance with an embodiment of the present invention.

FIG. 6 is an echo path amplitude frequency responses of FIG. 4 with terminated echo response for each loop subtracted in accordance with an embodiment of the present invention.

FIG. 7 is an illustration of one example of the environment in which the present invention operates.

FIG. 8 is a flow chart illustrating the method for determining whether a line is terminated, is an open circuit or a short circuit and the line length in accordance with an embodiment of the present invention for the two cases of post-deployment scenario, where. |H|Term data is available, and re-deployment scenario, where |H|Term data is not available.

### DETAILED DESCRIPTION OF THE INVENTION

A preferred embodiment of the present invention is now described with reference to the figures where like reference numbers indicate identical or functionally similar elements. Also in the figures, the left most digit of each reference number corresponds to the figure in which the reference number is first used.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

Embodiments of the present invention use a single ended line testing (SELT) method using a Frequency-Domain Reflectometry (FDR) that uses one or more echo signals originated by transmitting a periodic multi-tone signal, e.g., a REVERB signal, reflected from the hybrid, described below, and analyzes it in frequency domain. The REVERB signal is part of the ADSL modem training signal, therefore the invention can be simply implemented as part of the DMT-based DSL modem because transmitting a multi-tone signal and capturing the frequency response of echo are readily available through the inverse fast Fourier transform/fast Fourier transform (IFFT/FFT) blocks that are used for modulation and demodulation.

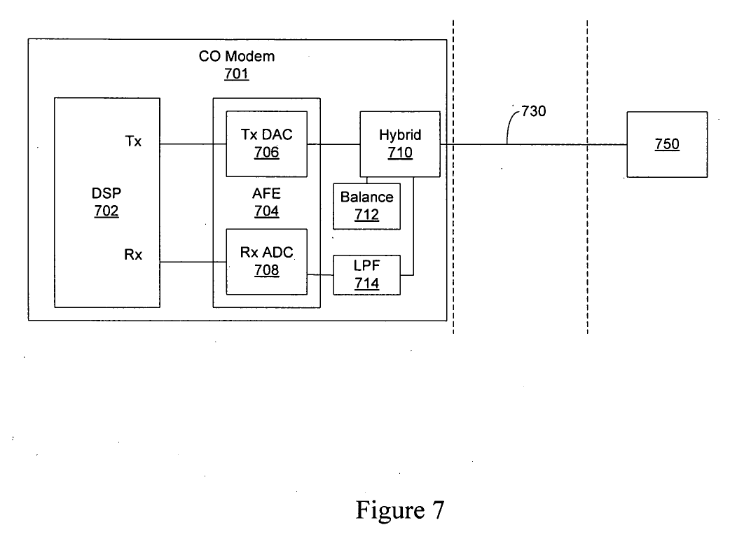

The present invention is able to recognize, from one end of a twisted-pair DSL line, if the other end of the line is open, short, or terminated and can estimate the length of the open or short point from the originating end of the line with reasonable accuracy. FIG. 7 is an illustration of an environment in which the one embodiment of the present invention can operate. In one embodiment, the originating end is a DSL modem 701, e.g., a central office (CO) modem, that has a digital signal processor 702 that includes a transmit (Tx) and receive (Rx) port that is coupled to an analog front end (AFE) 704 that includes, inter alia, a transmit digital-to-analog converter filter 706 and a receiving analog-to-digital converter filter 708. The modem 701 connects to the line 730 using a four-to-two wire converter circuit called a hybrid 710. The hybrid 710 connects to a balance that attempts to match the impedance of the line 730 and is also connected to a low pass filter 714 that is positioned between the hybrid 710 and the Rx ADC 708. At the unknown end of the line 750 there can be another modem or the line can be an open or short circuit, as described above.

The modem 701 periodically transmits a wide-band multi-tone signal and measures its reflection, the echo signal, from the hybrid through its echo path at its receiver. In one embodiment, this multi-tone signal is a REVERB signal that is part of an ADSL modem training signal. By periodically transmitting this multi-tone signal and averaging the captured echo signal over time the signal-to-noise ratio of the signal to be analyzed is improved. The echo path response of the hybrid is a function of the input impedance of the line Zᵢₙ. Zᵢₙ is the characteristic impedance of the line Z₀ as long as the other end is terminated by Z₀. Zᵢₙ deviates from Z₀ if the other end of the line 750 is not terminated by Z₀. When the other end is short or open Zᵢₙ is significantly different from Z₀. For an open or short loop, the frequency response of Zᵢₙ will also vary based upon the loop length. This is due to the fact that an open or short loop, or any loop that is not terminated by Z₀, will create standing waves along the line if excited by a sinusoid. The amplitude function of the standing waves at each point along the line is the envelope of two added sinusoids with the same frequency but having different phases. This is a periodic function with period of λ/2 where λ=ν/f. “ν” is speed of electric wave in the transmission line and “f” is the frequency of the sinusoid. “ν” is in the range of speed of light. For a lossless line, the maximum and minimum of the standing waves will be constant along the line, however, for a loop with loss they will vary with loop length. At a given length “L” the amplitude of the standing wave will vary with “f”. Therefore, Zᵢₙ will have ripples in its amplitude frequency response for a loop that is not terminated by Z₀. The amplitude of these ripples A(f) and their period “T” are functions of the loop length “L”. By measuring A(f) and “T” we can recognize if the loop is open, short, or terminated by Z₀ and estimate the length “L”.

As described above, an advantage of one embodiment of the present invention is that it can be implemented on legacy platforms through a firmware upgrade as it does not require any special hardware, special switches, or any other change on the modem front-end circuitry communicating data through wired line. Another advantage is its simplicity as it uses wideband multi-tone signal for data collection that is used in regular modem training and is readily available.

An infinitely long transmission line or a line terminated in its characteristic impedance is called a non-resonant line. A finite length line that is not terminated in its characteristic impedance is called a resonant line. The amplitude of a sinusoidal signal applied from the sending end of a non-resonant line when measured across the line will be constant for a lossless transmission line as there is no reflection from the receiving end. For a line with loss such as a twisted pair this amplitude will be monotonically decreasing along the line from the sending end. The loss of the line, the so called “insertion loss”, for the sinusoid is more at higher frequencies.

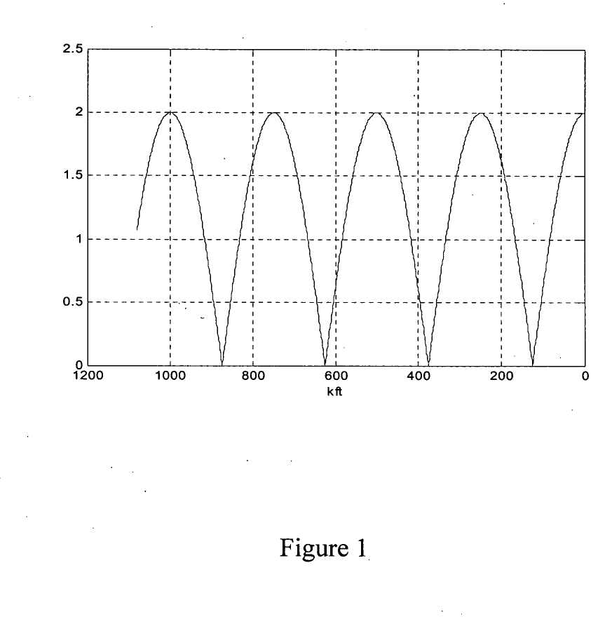

In a resonant line there is reflection from the receiving end. If the line is open the reflection voltage will be in phase, and it will have the same amplitude, with the incident wave at the reflection point (receiving end). The reflection coefficient is defined as Γ_{L}=(Z_{L}−Z₀)/( Z_{L}+Z₀) where Z₀ and Z_{L} are the characteristic impedance and load impedance, respectively. For an open loop, Z_{L} is infinite and Γ_{L}=1. For a short loop Z_{L} is zero and Γ_{L}=−1. Γ_{L} also equals the proportion of the reflected wave phasor to the incident wave phasor; i.e., Γ_{L}=Er/Ei. The reflected wave will travel back to the sending end and if the generator (signal transmitter) internal impedance Z_{g} is equal to Z₀ it will be absorbed at the generator with no reflection. Therefore, there are two waves along the line, the incident and the reflected waves. These two waves when combined create the so-called standing waves. The reflected wave will be added to the incident wave with different phases at different distance L from the receiving open end. At a distance λ/4 from the receiving end, the two waves are 180 degrees out of phase. The wavelength λ=ν/f where “ν” is speed of wave in the transmission line which is usually lower than speed of light but comparable and “f” is the frequency of the sinusoid wave. For a lossless line this means a complete cancellation. At a distance λ/2 from the receiving open end the two waves are in phase which means a doubling of amplitude for a lossless line. FIG. 1 is a plot of the amplitude of the standing waves for resonant lossless line with the receiving end open versus the distance from the receiving end in accordance with an embodiment of the present invention. Because the line is lossless, and the reflection coefficient is 1, the reflected wave has the same amplitude as the incident wave and therefore the minimum amplitude is as small as zero.

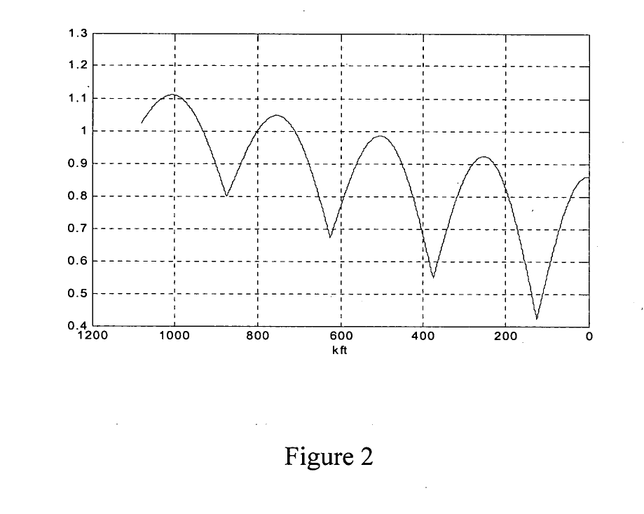

FIG. 2 is a plot of the amplitude of the standing waves for resonant line with loss, with receiving end open, versus the distance from the receiving end in accordance with an embodiment of the present invention. Because the wave attenuates as it travels along the line, the standing wave ratio, Emax/Emin, becomes smaller and smaller at distances further away from open end. Standing wave ratio is infinite for a lossless resonant line.

The impedance seen by the generator for various lengths of a resonant line is different. For an open ended resonant line the impedance is minimum at all odd quarter wavelength points from the open end. The impedance is a maximum at all even quarter wavelength points from the open end. At the maximum and minimum points the impedance is completely resistive. At a given length L the impedance may be at its max or min resistive or somewhere between and be capacitive or inductive depending on the frequency (f).

Accordingly, for a given open resonant loop Zᵢₙ at different frequencies there will be maximums and minimums along with values in-between. Therefore the frequency response of Zᵢₙ will have ripples in them.

The presence of ripples in Zᵢₙ can be proved mathematically using the formula for Zᵢₙ from transmission line theory, see for example, Sophocles J. Orfanidis, “Electromagnetic Waves and Antennas”, Rutgers University. For a loop with length L terminated by load impedance Z_{L}, the input impedance Zᵢₙ is given by equation (1).

$${Z}_{in} ( L ) = {Z}_{0} \cdot \frac{1 + {Γ}_{L} {ⅇ}^{- 2 {jβ}_{c} L}}{1 - {Γ}_{L} {ⅇ}^{- 2 {jβ}_{c} L}} \qquad ( 1 )$$

Where β_{c} is the propagation wave number that in general, for a loop with loss, is a complex number β_{c}=β−jα. β is propagation constant (β=2πf/ν)_and α is attenuation constant, both functions of frequency f. e^{-jβ}^{_{c}}^{L} is the transfer function of the line and e^{αL} is the loss of the line (amplitude response of its transfer function). For an open loop Γ_{L} is 1 and equation (1) reduces to equation (2).

$${Z}_{in} ( L ) = {Z}_{0} \cdot \frac{1 + {ⅇ}^{- 2 {jβ}_{c} L}}{1 - {ⅇ}^{- 2 {jβ}_{c} L}} \qquad ( 2 )$$

The amplitude response of Zᵢₙ is shown in equation (3).

$${\vert {Z}_{in} ( L , f ) \vert}^{2} = {\vert {Z}_{0} \vert}^{2} \cdot [ \frac{1 + {ⅇ}^{4 α ( f ) L} + 2 {ⅇ}^{2 α ( f ) L} Cos ( \frac{4 π fL}{v} )}{1 + {ⅇ}^{4 α ( f ) L} - 2 {ⅇ}^{2 α ( f ) L} Cos ( \frac{4 π fL}{v} )} ] \qquad ( 3 )$$

Assuming that the cosine term is much smaller than 1+e^{4α(f)L} term, equation (3) can be approximated as shown in equation (4).

$${\vert {Z}_{in} ( L , f ) \vert}^{2} \approx {\vert {Z}_{0} \vert}^{2} \cdot ( 1 + [ \frac{4 {ⅇ}^{2 α ( f ) L} Cos ( \frac{4 π fL}{v} )}{( 1 + {ⅇ}^{4 α ( f ) L} )} ] ) . \qquad ( 4 )$$

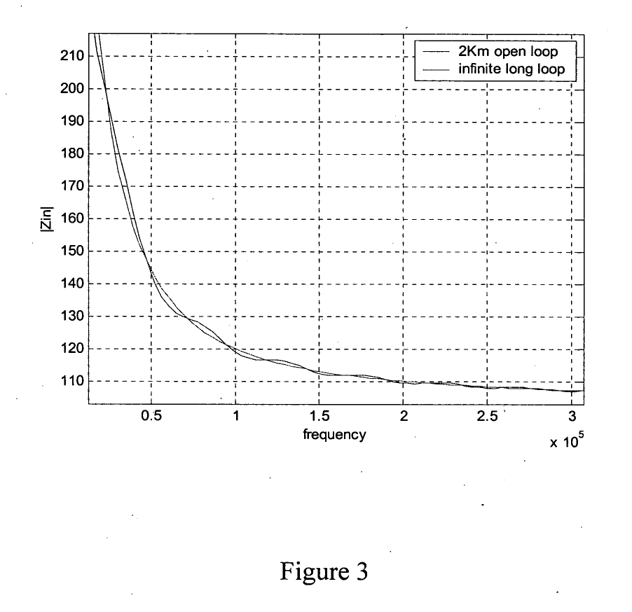

The presence of the above-mentioned ripples versus frequency fin |Zᵢₙ(L,f)| is apparent from equation (4). The frequency of the ripples increases with loop length L. The amplitude of the ripples decreases with loop length L and frequency f due to the loss factor e^{2α(f)L}. The factor 2 in the exponent is due to the round trip of the transmitted signal reflected from the open end. FIG. 3 is an amplitude frequency response of Zᵢₙ for a 2 kilometer (Km) open loop in accordance with an embodiment of the present invention.

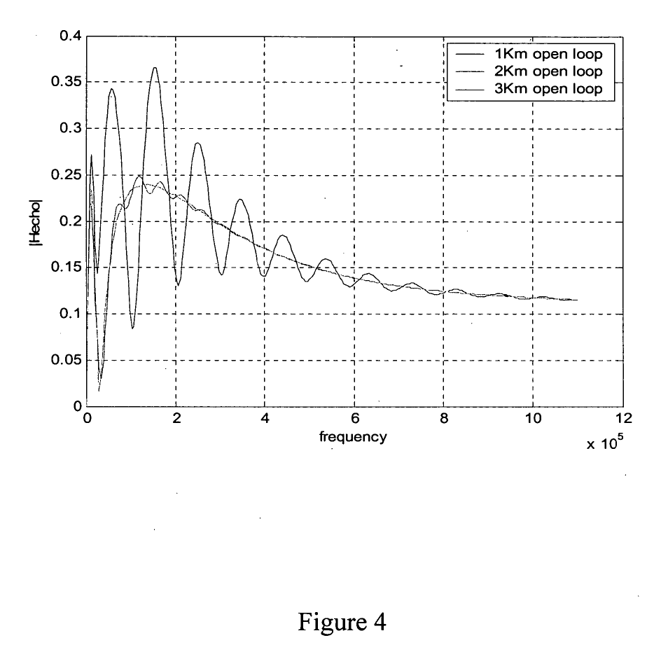

As discussed above the echo response of a hybrid circuit of the DSL modem is a function of Zᵢₙ. FIG. 4 is an echo path amplitude frequency response of a typical hybrid circuit for a 1, 2, 3 Km open loop in accordance with an embodiment of the present invention. As seen in FIG. 4, the amplitude of the ripples reduces by increasing loop length L and frequency f as predicted by equation (4).

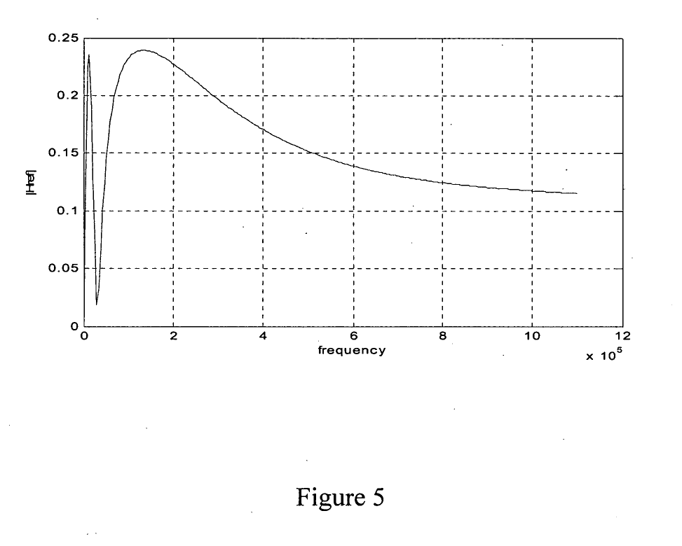

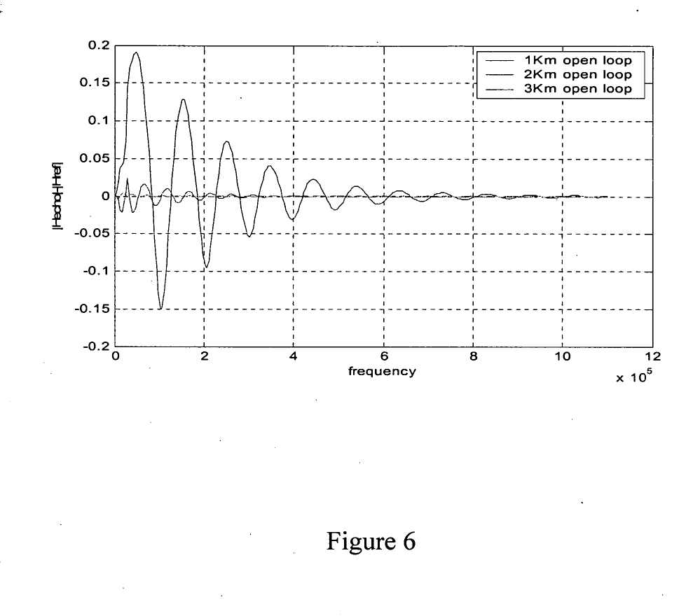

Both the amplitude and the frequency of the ripples are functions of the loop length L. By accurately measuring the amplitude and/or frequency of these ripples the present invention can determine the length of the loop, L. The amplitude of the ripples relative to the bulk of the echo signal, which corresponds to Z₀² term in equation (4), is too small for longer loops making the detection of the ripples difficult. However, the bulk of the echo response can be subtracted from the echo response before processing the ripples. The subtracted bulk of the echo, that we call reference, can be obtained by measuring the echo response on a terminated loop or equivalent circuit of an infinitely long loop. This reference signal will also have the information of the front-end components such as resistor, capacitors, analog-to-digital converters (ADC), digital-to-analog converters (DAC), etc. that when subtracted makes the measurements independent of these component's variation resulting in reduced port to port measurement error for the SELT algorithm. That is, by the above-mentioned subtraction component calibration is performed FIG. 5 is an echo path response of a terminated 5 Km loop in accordance with an embodiment of the present invention. FIG. 6 is an echo path frequency responses of FIG. 4 with terminated echo response for each loop subtracted in accordance with an embodiment of the present invention.

Detecting the ripple amplitude energy and their period is easier after subtraction, illustrated in FIG. 6. By detecting the amplitude power and/or period of the ripples we can accurately determine whether the other end is open and determine its length.

A similar discussion is valid for the case of shorted receiver end. In the short case, the reflected voltage wave has 180 degree phase reversal with respect to the incident voltage wave at the reflection point because Γ_{L}=−1, unlike the open case that are in-phase Γ_{L}=1.

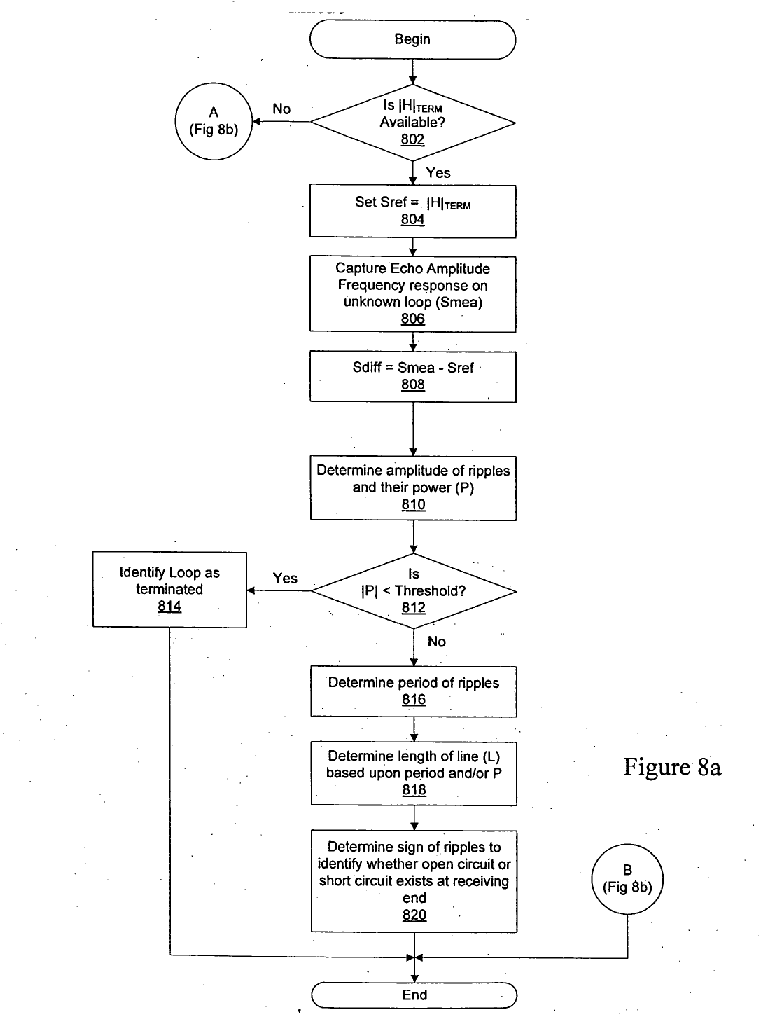

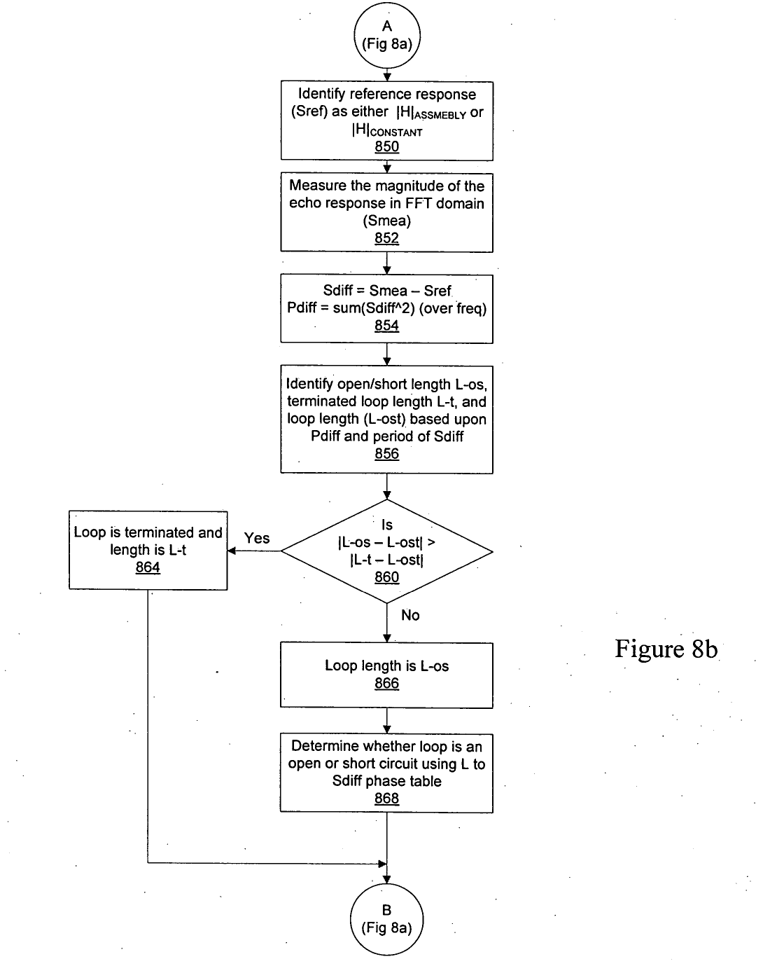

Based, in part, upon the above discussion, the operation of one embodiment of the present invention is described in FIG. 8. FIG. 8 is a flow chart illustrating the method for determining whether a line is terminated, is an open circuit or a short circuit and the line length in accordance with an embodiment of the present invention. The process begins by determining 802 whether terminated reference data |H|_{Term} is available on the subscriber line. |H|_{Term} is the amplitude frequency response of the hybrid circuit echo path, in other words it is the amplitude of the FFT of the echoed REVERB signal transmitted by the transmitter. Typically |H|_{Term} data is available when measurements on the subscriber line occur after deployment of the modem 701 at a time when what is referred to as the unknown end of the line 750 in FIG. 7 is known and is typically another ADSL modem, e.g., a customer premise equipment (CPE) modem. Alternatively, one of two other reference data will be used: |H|_{Assembly} or |H|_{Constant} |H|_{Assembly} data can be created by capturing the echo amplitude frequency response on the equivalent of a very long loop—which can be done during assembly of the modem 701. |H|_{Assembly} will be used if |H|_{Term} is not available. |H|_{Constant} is a pre-calculated or pre-measured and stored data. It can be theoretically computed or it can be an averaged data across many ports on equivalent of a long terminated loop. This data is captured similarly to the other two data and computed once in the lab and stored, therefore using this data will not provide any per-port calibration capability which translates to less accurate loop length estimates. |H|_{Constant} will be used if neither |H|_{Term} nor |H|_{Assembly} is available. Depending on which of |H|_{Term}, |H|_{Assembly},or |H|_{Constant} is available and typically selected, prioritized in the above order, it will be called Sref and the algorithm will follow.

If |H|_{Term} data is available then the present invention sets 804 the Sref=|H|_{Term} data. Then the present invention captures 806 the echo frequency response on the current loop that has an unknown termination using the same transmitted signal that was used to capture |H|_{Term} (Sref). This (can be accomplished in a variety of ways including sending a multi-tone signal, e.g., a REVERB signal, down the line 530 and measuring the response, as discussed above. The measured echo amplitude frequency response is referred to herein as Smea. The DSP 702 or another entity on-board such as a network processor or an independent PC, etc, then determines the difference (Sdiff) as the difference 808 between Smea and Sref. In an alternative embodiment, the determination of the difference, Sdiff, and the determination of the length and type of end of line generally, e.g., whether it's terminated, is an open circuit or a short circuit, can be done in whole or in part on a processor that is external to the modem 701. The DSP 702 or another entity then determines 810 the amplitude of the ripples and their power (P) as described above, for example. If the absolute value of the power of the ripples is less than a threshold value 812 then the present invention identifies 814 the loop as being terminated and the process ends.

If the absolute value of the power of the ripples is greater than a threshold value 812 then the DSP 702 determines 816 the period of the ripples as set forth above. Then the present invention uses a look-up table to determine 818 the length of the line 730 based upon the measured ripple power (P) and/or the period of the ripples. The present invention then determines 820 the sign of the ripples to identify whether the loop has an open circuit or a short circuit at the receiving (unknown) end 750, as described above.

With reference to step 802, if |H|_{Term} data is not available the process continues in FIG. 8b at step 850. In this situation we do not have terminated reference data based upon the actual post-deployment environment. In this case, the present invention looks for terminated reference data captured during modem assembly on equivalent of a long terminated loop per each modem port |H|_{Assembly}. If this data is not available either, the present invention identifies a reference response (Sref) based upon pre-calculated or pre-measured data |H|_{Constant}. The present invention then sends a multi-tone signal down the line 730 and measures 852 the magnitude of the echo response in a FFT domain. The measured response is referred to herein as Smea. The DSP 702 then determines 854 the difference (Sdiff) between Smea and Sref and also determines the power difference, referred to herein as Pdiff, as the sum of square of the vector Sdiff over the various frequencies of the multi-tone signal. The present invention then identifies 854 the length of the loop (L-os) assuming open/short cases through the pre-stored Pdif power to loop length (open/short cases) table. The present invention also identifies 854 the length of the loop (L-t) if the loop is terminated, for example if it's terminated with a CPE modem, based upon a pre-stored table that correlates the length of the loop (L-t) to Pdiff.

The present invention also identifies the length of the loop (L-ost) based upon an estimation of the period of S_diff (that the invention determines) and using a table to correlate the length (L-ost) to the period of Sdiff. It will be apparent that instead of or in addition to using tables, other correlation techniques can be used.

The present invention then determines 860 whether the absolute value of the difference between L-os and L-ost is greater than the absolute value of the difference between L-t and L-ost. If so, the present invention identifies 864 the loop as being terminated and the length identified as L-t. Otherwise, the loop ends as either an open or short circuit and the length is identified as L-os. The present invention can also identify whether the line 730 is an open or short circuit based upon a table using the loop and the phase of Sdiff, as described above. The process then ends.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatus of the present invention without departing from the spirit and scope of the invention as it is defined in the claims.

What is claimed is:

1. A method for determining a state of a receiving end of a communications line in a communication system, comprising the steps of:
identifying a first echo frequency response signal on the communications line by transmitting a multi-tone signal on the communications line and measuring the amplitude frequency response in a given frequency range of a reflected signal that has reflected from the receiving end when the receiving end is terminated;
transmitting a multi-tone signal on the communications line and measuring the amplitude frequency response of a reflected signal that has reflected from the receiving end to identify a second echo amplitude frequency response signal in a given frequency range on the communications line when the state of the receiving end is unknown;
determining a difference signal having ripples based upon a difference between said first and second echo amplitude frequency response signals;
determining a first power of said ripples in the said difference signal;
identifying the state of the receiving end as terminated when said first power is within a first range; and
identifying the state of the receiving end as non-terminated when said first power is not within said first range.

2. The method of claim 1, further comprising the steps of:
determining a first period corresponding to a period of said ripples; and
identifying a first length corresponding to a length of the communications line when the state of the receiving end is non-terminated based upon said first power.

3. The method of claim 2, further comprising the step of:
identifying said non-terminated state of the receiving end as one of an open circuit or a short circuit based upon a phase of said difference signal and said first length.

4. A method for determining a length of a communications line in a communication system, comprising the steps of:
identifying a first echo frequency response signal on the communications line by transmitting a multi-tone signal on the communications line and measuring the frequency response in a given frequency range of a reflected signal that has reflected from the receiving end when the receiving end is terminated or equivalent to terminated;
transmitting a multi-tone signal on the communications line and measuring the frequency response of a reflected signal that has reflected from the receiving end to identify a second echo frequency response signal in a given frequency range on the communications line when the state of the receiving end is unknown;
determining a difference signal having ripples based upon a difference between said first and second echo frequency response signals; and
determining a first period corresponding to a period of said ripples in said difference signal.

5. The method of claim 4, further comprising the step of:
determining a first length, corresponding to a length of the communications line, based upon said first period.

6. A method for determining a state of a receiving end of a communications line in a communication system, comprising the steps of:
identifying a first echo frequency response signal on the communications line by using pre-stored echo data;
transmitting a multi-tone signal on the communications line and measuring the frequency response of a reflected signal that has reflected from the receiving end to identify a second echo frequency response signal in a given frequency range on the communications line when the state of the receiving end is unknown;
determining a difference signal having ripples based upon a difference between said first and second echo frequency response signals;
determining a first power of said ripples in the said difference signal; and
determining a first period corresponding to a period of said ripples in the said difference signal.

7. The method of claim 6, further comprising the steps of:
determining a first length corresponding to a length of the communication line when the receiving end is terminated based upon said first power;
determining a second length corresponding to a length of the communication line when the receiving end is non-terminated based upon said first power; and
determining a third length corresponding to a length of the communication line based upon said first period using a period to length mapping.

8. The method of claim 7 further comprising the steps of:
identifying the state of the receiving end as terminated if said third length is closer to said first length than to said second length; and
identifying said first length corresponding to a length of the communications line if said third length is closer to said first length than to said second length.

9. The method of claim 7, further comprising the steps of:
identifying the state of the receiving end as non-terminated if said third length is closer to said second length than to said first length; and
identifying said second length corresponding to a length of the communications line if said third length is closer to said second length than to said first length.

10. The method of claim 9 further comprising the step of:
identifying the non-terminated state of the receiving end as one of an open circuit or a short circuit based upon a phase of said difference signal and said second length.

11. The method of claim 6, wherein the communication system includes a modem and wherein the pre-stored echo data used as reference data is an echo frequency response signal data captured when the communication system is connected to a long terminated line or an equivalent of long terminated line.

12. The method of claim 6, where the pre-stored echo data used as reference data is a data averaged over two or more echo frequency response signals captured on a terminated long loop or an equivalent of terminated long loop across different communication ports.

13. A system for determining a state of a receiving end of a communications line in a communication system, comprising:
first echo means for identifying a first echo frequency response signal on the communications line by transmitting a multi-tone signal on the communications line and measuring the amplitude frequency response in a given frequency range of a reflected signal that has reflected from the receiving end when the receiving end is terminated;
transmitting means for transmitting a multi-tone signal on the communications line and measuring the amplitude frequency response of a reflected signal that has reflected from the receiving end to identify a second echo amplitude frequency response signal in a given frequency range on the communications line when the state of the receiving end is unknown;
difference means for determining a difference signal having ripples based upon a difference between said first and second echo amplitude frequency response signals;
ripple power means for determining a first power of said ripples in the said difference signal;
state identifying means for identifying the state of the receiving end as terminated when said first power is within a first range and for identifying the state of the receiving end as non-terminated when said first power is not within said first range.

14. The system of claim 13, further comprising:
period means for determining a first period corresponding to a period of said ripples; and
first length means for identifying a first length corresponding to a length of the communications line when the state of the receiving end is non-terminated based upon said first power.

15. The system of claim 14, further comprising:
non-terminated state identifying means for identifying said non-terminated state of the receiving end as one of an open circuit or a short circuit based upon a phase of said difference signal and said first length.

16. A system for determining a length of a communications line in a communication system, comprising:
first echo means for identifying a first echo frequency response signal on the communications line by transmitting a multi-tone signal on the communications line and measuring the frequency response in a given frequency range of a reflected signal that has reflected from the receiving end when the receiving end is terminated or equivalent to terminated;
transmitting means for transmitting a multi-tone signal on the communications line and measuring the frequency response of a reflected signal that has reflected from the receiving end to identify a second echo frequency response signal in a given frequency range on the communications line when the state of the receiving end is unknown;
difference means for determining a difference signal having ripples based upon a difference between said first and second echo frequency response signals; and
first period means for determining a first period corresponding to a period of said ripples in said difference signal.

17. The system of claim 16, further comprising:
first length means for determining a first length, corresponding to a length of the communications line, based upon said first period.

18. A system for determining a state of a receiving end of a communications line in a communication system, comprising:
first echo means for identifying a first echo frequency response signal on the communications line by using pre-stored echo data;
transmitting means for transmitting a multi-tone signal on the communications line and measuring the frequency response of a reflected signal that has reflected from the receiving end to identify a second echo frequency response signal in a given frequency range on the communications line when the state of the receiving end is unknown;
difference means for determining a difference signal having ripples based upon a difference between said first and second echo frequency response signals;
ripple power means for determining a first power of said ripples in the said difference signal; and
first period means for determining a first period corresponding to a period of said ripples in the said difference signal.

19. The system of claim 18, further comprising:
first length means for determining a first length corresponding to a length of the communication line when the receiving end is terminated based upon said first power, for determining a second length corresponding to a length of the communication line when the receiving end is non-terminated based upon said first power, and for determining a third length corresponding to a length of the communication line based upon said first period using a period to length mapping.

20. The system of claim 19 further comprising:
state means for identifying the state of the receiving end as terminated if said third length is closer to said first length than to said second length, and for identifying said first length corresponding to a length of the communications line if said third length is closer to said first length than to said second length.

21. The system of claim 19, further comprising:
state means for identifying the state of the receiving end as non-terminated if said third length is closer to said second length than to said first length, and for identifying said second length corresponding to a length of the communications line if said third length is closer to said second length than to said first length.

22. The system of claim 21 further comprising:
non-terminated state means for identifying the non-terminated state of the receiving end as one of an open circuit or a short circuit based upon a phase of said difference signal and said second length.

23. The system of claim 18, wherein the communication system includes a modem and wherein the pre-stored echo data used as reference data is an echo frequency response signal data captured when the communication system is connected to a long terminated line or an equivalent of long terminated line.

24. The system of claim 18, where the pre-stored echo data used as reference data is a data averaged over two or more echo frequency response signals captured on a terminated long loop or an equivalent of terminated long loop across different communication ports.
